(19) United States
(12) Patent Application Publication
(10) Pub. No.: US 2016/0241171 A1
(43) Pub. Date: Aug. 18, 2016

(54) Device for Monitoring Synchronous Signals of a Motor

(71) Applicant: I-SHOU UNIVERSITY, Kaohsiung City (TW)

(72) Inventors: Rong-Ching Wu, Kaohsiung City (TW); Ping-Tsang Wu, Kaohsiung City (TW); Chung-Da Lee, Kaohsiung City (TW); Ching-Tai Chiang, Kaohsiung City (TW)

(21) Appl. No.: 14/666,343

(22) Filed: Mar. 24, 2015

(30) Foreign Application Priority Data
Feb. 16, 2015 (TW) 104105357

(51) Int. Cl. H02P 6/00

(52) U.S. Cl. CPC H02P 6/002

(57) ABSTRACT

A device for monitoring synchronous signals of a motor includes a detection module and a processor. The detection module includes a rotational speed detector and an electric detector. The rotational speed detector is adapted to detect a rotational speed of a motor to generate a rotational speed signal. The electric detector is adapted to detect a current value and a voltage value between the motor and a power supply to generate a current signal and a voltage signal, respectively. The processor is electrically connected to the detection module to receive the rotational speed signal, the current signal, and the voltage signal. The processor generates an analysis result according to instant values of the rotational speed signal, the current signal, and the voltage signal at a same time point. The detection accuracy of the operating status of the motor is, thus, increased.

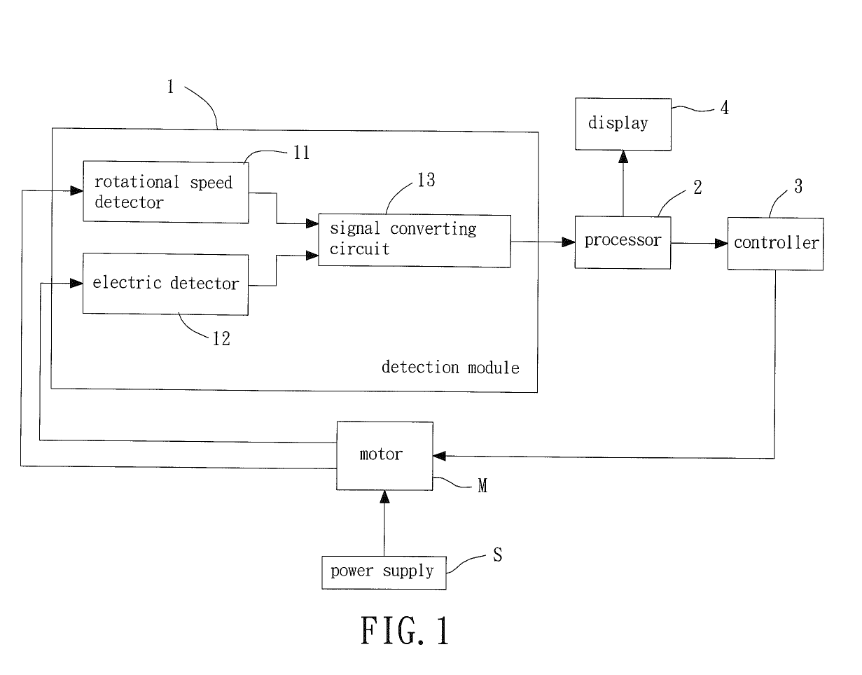

### BACKGROUND OF THE INVENTION

1. Field of the Invention

The present invention relates to a device for monitoring synchronous signals of a motor and, more particularly, to a monitoring device capable of synchronously detecting a plurality of measurement signals of a motor.

2. Description of the Related Art

Precise control of machine movement to maintain automated production is a critical factor of increasing the production rate and quality of products. To fulfill the need of automated production of the machine, the first priority is to precisely control the current operation conditions of the machine, such that correct operation orders can be given at the correct time to control the machine.

Taking the control of a motor as an example, the operating status of the motor must be detected before controlling the motor with a controller. For example, a detector is used to detect the rotational speed of the motor and generates a detection signal that is sent to the controller. The controller can judge the current operating status of the motor according to the detection signal and can output a control signal to drive the motor according to the operating status.

However, there are many factors affecting the rotational speed of a motor. The rotational speed of the motor changes when the driving current of the motor changes or the driving voltage of the motor is unstable. If only the rotational speed of the motor is considered while other information, such as the driving current or the driving voltage, is ignored, normal operation of the motor cannot be accurately identified, leading to poor detection accuracy of the operating status of the motor.

Thus, a need exists for improvement to the conventional motor monitoring devices to solve the problem of inaccurate detection of the conventional motor monitoring devices.

### SUMMARY OF THE INVENTION

An objective of the present invention is to provide a device for monitoring synchronous signals of a motor to increase the detection accuracy of the operating status of the motor.

The present invention fulfills the above objective by providing a device for monitoring synchronous signals of a motor including a detection module and a processor. The detection module includes a rotational speed detector and an electric detector. The rotational speed detector is adapted to detect a rotational speed of a motor to generate a rotational speed signal. The electric detector is adapted to detect a current value and a voltage value between the motor and a power supply to generate a current signal and a voltage signal, respectively. The processor is electrically connected to the detection module to receive the rotational speed signal, the current signal, and the voltage signal. The processor generates an analysis result according to instant values of the rotational speed signal, the current signal, and the voltage signal at a same time point.

The detection module can be electrically connected to the processor by a power line carrier.

The detection module further includes a signal converting circuit electrically connected to the rotational speed detector and the electric detector and receiving the rotational speed signal, the current signal, and the voltage signal, and with the signal converting circuit carrying out digital or analogical conversion of the rotational speed signal, the current signal, and the voltage signal and then outputting the rotational speed signal, the current signal, and the voltage signal to the processor.

The device for monitoring synchronous signals of a motor can further include a controller electrically connected to the processor. The controller receives the analysis result and generates a control signal for driving the motor according to the analysis result.

The controller can be electrically connected to the processor by a power line carrier.

The processor can be electrically connected to a display. The display receives the rotational speed signal, the current signal, and the voltage signal. The display displays response values corresponding to the rotational speed signal, the current signal, and the voltage signal. The display receives and displays the analysis result.

Based on the above, the rotational speed signal, the current signal and the voltage signal of the motor can be measured to identify the operating status of the motor, increasing the detection accuracy of the operating status of the motor.

The present invention will become clearer in light of the following detailed description of illustrative embodiments of this invention described in connection with the drawings.

### BRIEF DESCRIPTION OF THE DRAWINGS

The FIGURE shows a block diagram illustrating a device for monitoring synchronous signals of a motor according to the present invention.

### DETAILED DESCRIPTION OF THE INVENTION

With reference to the FIGURE, a device for monitoring synchronous signals of a motor according to the present invention includes a detection module 1 and a processor 2. The detection module 1 is used to detect parameters of a motor “M.” The processor 2 is electrically connected to the detection module 1.

The detection module 1 including a rotational speed detector 11 and an electric detector 12. The rotational speed detector 11 is adapted to detect a rotational speed of the motor “M” to generate a rotational speed signal. The electric detector 12 is adapted to detect a current value and a voltage value between the motor “M” and a power supply S to generate a current signal and a voltage signal, respectively.

Specifically, the motor “M” is electrically connected to the power supply S, such that the motor “M” can receive driving power from the power supply S. The driving power includes the voltage value and the current value. Thus, when the motor “M” operates, the rotational speed detector 11 detects the rotational speed of the motor “M” and generates the rotational speed signal. The electric detector 12 also can detect the current value and the voltage value of the driving power between the motor “M” and the power supply S to generate the current signal and the voltage signal, respectively. The rotational speed signal, the current signal, and the voltage signal can be used in subsequent information processing to identify the operating status of the motor “M,” increasing the detection accuracy of the operating status of the motor “M.” The types of the rotational speed detector 11 and the electric detector 12 are not limited. In this embodiment, the rotational speed detector 11 is a detector having a pulse wave calculation function, such that the rotational speed of the motor “M” can be estimated through pulse wave calculation. The electric detector 12 includes a photo coupler for detecting the voltage value and a Hall element for detecting the current value.

Furthermore, the rotational speed detector 11 includes a signal converting circuit 13 electrically connected to the rotational speed detector 11 and the electric detector 12 and receiving the rotational speed signal, the current signal, and the voltage signal. The signal converting circuit 13 undergoes digital or analogical conversion of the rotational speed signal, the current signal, and the voltage signal and then outputs the rotational speed signal, the current signal, and the voltage signal to the processor 2. By providing the signal converting circuit 13, the rotational speed signal, the current signal, and the voltage signal can be converted into information of a type acceptable to the processor 2, such that the processor 2 can receive and accurately read the rotational speed signal, the current signal, and the voltage signal to maintain normal information judgment operation.

The processor 2 is electrically connected to the detection module 1 to receive the rotational speed signal, the current signal, and the voltage signal. The processor 2 generates an analysis result according to instant values of the rotational speed signal, the current signal, and the voltage signal at the same time point.

Specifically, since the values of the rotational speed signal, the current signal, and the voltage signal change with time, the processor 2 synchronizes the sampling time of the rotational speed signal, the current signal, and the voltage signal after the processor 2 receives the rotational speed signal, the current signal, and the voltage signal. Furthermore, the instant values of the rotational speed signal, the current signal, and the voltage signal at the same time point can be picked up and used as the judgment data of the operating status of the motor “M.” Thus, in addition to judging the instant rotational speed of the motor “M” according to the instant values, the processor 2 can also judge the instant current and the instant voltage according to the current signal and the voltage signal and can further judge the relationship between the rotational speed change of the motor “M” and the current value change or the voltage value change at the same time point, thereby accurately judging the operating status of the motor “M.” Thus, the detection accuracy of the operating status of the motor “M” is increased.

The electrical connection between the detection module 1 and the processor 2 is not limited. In this embodiment, the detection module 1 is electrically connected to the processor 2 by a power line carrier (PLC).

Specifically, the power line carrier uses an existing power line as the communication line carrier for carrier wave communication in a normal low-voltage power supply system (the voltage is 220V or 110V), modulates the to-be-transmitted-signal onto the carrier wave, and then undergoes low-speed carrier wave communication through the lower line by carrier wave. Thus, the detection module 1 and the processor 2 do not have to include additional communication equipment. When the detection module 1 and the processor 2 are electrically connected to a power supply end of mains electricity, the detection module 1 can transmit the rotational speed signal, the current signal, and the voltage signal to the processor 2 through the existing power line, such that the processor 2 can proceed with subsequent information processing, increasing the information transmission convenience.

Furthermore, in addition to the digital or analogical conversion of the rotational speed signal, the current signal, and the voltage signal, the signal converting circuit 13 of the detection module 1 can also proceed with modulation of the carrier wave, such that the above signals undergo low-speed carrier wave communication through the lower line. Furthermore, the processor 2 can also include a demodulation module. After receiving the above signals, the processor 2 can undergo demodulation processing to correctly read the rotational speed signal, the current signal, and the voltage signal, increasing information transmission convenience and maintaining normal information judgment operation.

The device for monitoring synchronous signals of a motor according to the present invention further includes a controller 3 electrically connected to the processor 2. The controller 3 receives the analysis result and generates a control signal for driving the motor “M” according to the analysis result.

Specifically, the controller 3 can be a driving circuit for the motor “M” and is electrically connected to the motor “M.” When the controller 3 serves as a portion of an automation control module, the controller 3 can receive the analysis result from the processor 2 and can decide the driving operation of the motor “M” at the next time point according to the analysis result. Then, the controller 3 outputs a corresponding control signal to drive the motor “M.” Since the processor 2 obtains the analysis result through synchronous operation on the rotational speed signal, the current signal, and the voltage signal and since the analysis result can more accurately present the operating status of the motor “M,” after receiving the analysis result, the controller 3 can drive the motor “M” to operate in the most accurate way, increasing the operational control accuracy of the motor “M.”

Moreover, the electrical connection between the processor 2 and the controller 3 is not limited to any form. In the embodiment, the processor 2 is electrically connected to the controller 3 by the power line carrier. Thus, the processor 2 and the controller 3 do not have to include additional communication equipment. When the processor 2 and the controller 3 are electrically connected to the power supply end of mains electricity, the processor 2 can transmit the analysis result to the controller 3 through the existing power line, such that the controller 3 can proceed with the subsequent driving operation, increasing the information transmission convenience.

In addition, the processor 2 can also proceed with the modulation of the carrier wave for the analysis result, such that the analysis result undergoes low-speed carrier wave communication through the lower line. Furthermore, the controller 3 can also include a demodulation module. After receiving the analysis result, the analysis result can undergo the demodulation processing to correctly read the operating status of the motor “M,” increasing information transmission convenience and maintaining normal information judgment operation.

Furthermore, the device for monitoring synchronous signals of a motor according to the present invention further includes a display 4 electrically connected to the processor 2. The display 4 receives the rotational speed signal, the current signal, and the voltage signal and displays response values corresponding to the rotational speed signal, the current signal, and the voltage signal. Furthermore, the display 4 receives and displays the analysis result. Thus, the display 4 can display the related information of the motor “M” detected by the detection module 1, including the rotational speed, the current, and the voltage. Furthermore, the display 4 can display the current operating status of the motor “M,” permitting a user to clearly understand the related information of the motor “M,” increasing the use convenience.

In view of the foregoing, the device for monitoring synchronous signals of a motor according to the present invention accurately judges the current operating status of the motor “M” through synchronous detection of the rotational speed signal, the current signal, and the voltage signal during operation of the motor “M,” increasing the detection accuracy of the operating status of the motor “M.”

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

What is claimed is:

1. A device for monitoring synchronous signals of a motor, comprising:
a detection module including a rotational speed detector and an electric detector, with the rotational speed detector adapted to detect a rotational speed of a motor to generate a rotational speed signal, with the electric detector adapted to detect a current value and a voltage value between the motor and a power supply to generate a current signal and a voltage signal, respectively; and
a processor electrically connected to the detection module to receive the rotational speed signal, the current signal, and the voltage signal, with the processor generating an analysis result according to instant values of the rotational speed signal, the current signal, and the voltage signal at a same time point.

2. The device for monitoring synchronous signals of a motor as claimed in claim 1, wherein the detection module is electrically connected to the processor by a power line carrier.

3. The device for monitoring synchronous signals of a motor as claimed in claim 1, with the detection module further including a signal converting circuit electrically connected to the rotational speed detector and the electric detector and receiving the rotational speed signal, the current signal, and the voltage signal, and with the signal converting circuit carrying out digital or analogical conversion of the rotational speed signal, the current signal, and the voltage signal and then outputting the rotational speed signal, the current signal, and the voltage signal to the processor.

4. The device for monitoring synchronous signals of a motor as claimed in claim 1, further comprising a controller electrically connected to the processor, with the controller receiving the analysis result and generating a control signal for driving the motor according to the analysis result.

5. The device for monitoring synchronous signals of a motor as claimed in claim 4, wherein the controller is electrically connected to the processor by a power line carrier.

6. The device for monitoring synchronous signals of a motor as claimed in claim 1, with the processor electrically connected to a display, with the display receiving the rotational speed signal, the current signal, and the voltage signal, with the display displaying response values corresponding to the rotational speed signal, the current signal, and the voltage signal, and with the display receiving and displaying the analysis result.
